(19) United States
(12) Patent Application Publication
(10) Pub. No.: US 2025/0390535 A1
(43) Pub. Date: Dec. 25, 2025

(54) SMART GRAPH-BASED DOCUMENT GENERATION

(71) Applicants: AMIT BANDYOPADHYAY, Sacramento, CA (US); ESHA BANERJEE, Sacramento, CA (US)

(72) Inventors: AMIT BANDYOPADHYAY, Sacramento, CA (US); ESHA BANERJEE, Sacramento, CA (US)

(73) Assignee: Sacramento Consulting Group LLC, Sacramento, CA (US)

(21) Appl. No.: 19/243,575

(22) Filed: Jun. 19, 2025

Related U.S. Application Data
(60) Provisional application No. 63/662,770, filed on Jun. 21, 2024.

(51) Int. Cl. G06F 16/901; G06F 16/22; G06F 16/34

(52) U.S. Cl. CPC G06F 16/9024; G06F 16/2228; G06F 16/345

(57) ABSTRACT

Embodiments provide for techniques for facilitating graph-based generation of documents. For example, a method may include generating, by a computing device, a hierarchical table of contents (TOC) having section headings relating to a document to be assembled. The method may further include constructing a graph having nodes corresponding to one or more of section headings associated with sections and graph edges corresponding to section dependencies associated with the section headings. The method may further include assembling the document by concatenating section contents corresponding to the section headings based on a user-defined formatting template.

### CROSS REFERENCE

This Patent Application claims priority to and the benefit of U.S. Provisional Patent Application, No. 63/662,770, Graph Approach to Document Generation Using LLM, filed Jun. 21, 2024.

### FIELD

One or more implementations relate generally to document generation in computing environments, and more specifically, to graph-based document generation using large language models in computing environments.

### BACKGROUND

Conventional document generation techniques, whether monolithic single-prompt techniques or rigid form-based techniques, are severely limited in terms scalability, coherence, and flexibility. For example, monolithic single-prompt techniques can be ineffective for complex tasks as such a technique can overwhelm a model, which, in turn, leads to inaccurate results. Similarly, for example, rigid form-based techniques are limited and inflexible when dealing with unknown or unfamiliar tasks that are outside their known or predetermined structure.

Any subject matter discussed in the background section should not be assumed to be prior art merely as a result of its mention in the background section. The subject matter in the background section merely represents different approaches.

### BRIEF DESCRIPTION OF THE DRAWINGS

In the following drawings like reference numbers are used to refer to like elements.

Although the following figures depict various examples, one or more implementations are not limited to the examples depicted in the figures and that alternative implementations are within the spirit and scope of the appended claims.

FIG. 1 illustrates a system having a computing device employing a graph-based document generation mechanism according to one embodiment.

FIG. 2 illustrates a graph-based document generation mechanism of FIG. 1 according to one embodiment.

FIGS. 3A and 3B are screengrabs illustrating features of Table of Contents generation logic of FIG. 2 according to one embodiment.

FIGS. 3C and 3D are screengrabs illustrating features of section-level large language models logic of FIG. 2 according to one embodiment.

FIG. 4 illustrates a transaction sequence for facilitating document generation in a computing environment based on a graph-based document generation mechanism of FIG. 1 according to one embodiment.

FIG. 5 illustrates a method for facilitating document generation in a computing environment based on a graph-based document generation mechanism of FIG. 1 according to one embodiment.

FIG. 6 illustrates a diagrammatic representation of a machine 600 in the exemplary form of a computer system, in accordance with one embodiment, within which a set of instructions, for causing machine 600 to perform any one or more of the methodologies discussed herein, may be executed.

### DETAILED DESCRIPTION

In the following description, numerous specific details are set forth. However, embodiments of the invention may be practiced without these specific details. In other instances, well-known circuits, structures, and techniques have not been shown in detail in order not to obscure the understanding of this description.

Embodiments provide for a technique for facilitating graph-based document generation using modular large language models (LLMs) in computing environments including cloud computing environments.

In one embodiment, a novel technique is presented for generating long-form documents by combining LLMs with dynamically constructed graphs. This novel technique further provides for graph-based modular system for decomposing of a document into interconnected sections (also referred to as “nodes”) that are handled by a specialized LLM agent. This novel technique enables incremental generation, version control, and improved factual inconsistency, while avoiding context-window constraints.

As forementioned, conventional techniques are severely limited in many ways, such as with respect to complexity of performance, inaccuracy of results, etc. One such limitations is token window constraints which, for example, applies to monolithic generation techniques and form-based (template-driven) systems. With respect to a monolithic generation technique, the token window constraint allows the technique to exceed a model's context window when producing long documents (such as multi-chapter whitepapers, technical reports, etc.) while risking “falling out” of context, leading to omissions or incoherence. Regarding a form-based system, the documents breaks into fields but still rely on a single model to stitch everything together.

Another limitation associated with various conventional techniques is the lack of real-time feedback. When users fill out form fields, they often do so without seeing how the content might integrate with the final documents. This often leads to a blinding process that results in a wasted effort if the assembled text does not match expectations. Another limitation being the difficulty with interactive edits. In monolithic workflows, updating a section typically requires rerunning the entire generation, which can be time-consuming and costly since tokens are billed per request. Similarly, form-based systems offer rigid templates and adjustment of structures (e.g., adding or merging sections) requiring manual template revisions.

Further limitations associated with conventional techniques include hallucinations and inconsistencies and limited granular control. With respect to hallucinations and inconsistencies, without intermediate checkpoints or summary alignments, monolithic LLMs can drift off topic or introduce factual errors. Similarly, form-based systems lack automated coherence checks across fields, so definitions or terms introduced early may not align with later sections. Regarding limited granular control, users tends to have minimal control over style, tone, content granularity, etc., in each section, such as the one-size-fits-all prompts do not easily adapt to specialized knowledge domains or audience requirements.

Any of the embodiments may be used alone or together with one another in any combination. There may be embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the Specification. Some embodiments may only partially address some deficiencies or just one deficiency that may be discussed in the Specification, and some embodiments may not address any of these deficiencies.

It is contemplated that embodiments and their implementations are not merely limited to any particular type or form of computing systems or environments, such as cloud computing environments, multi-tenant database system, client-server systems, mobile devices, personal computers, web services environment, etc.

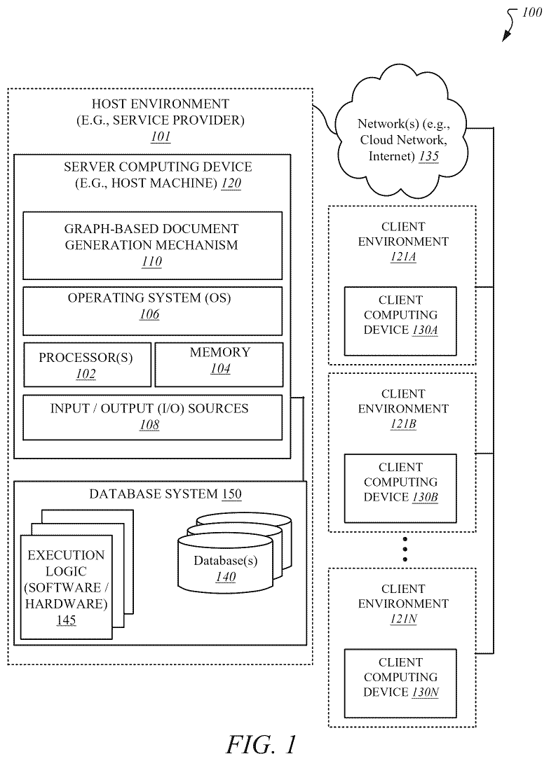

FIG. 1 illustrates a system 100 having a computing device 120 employing a graph-based document generation mechanism (“graph mechanism”) 110 according to one embodiment. In one embodiment, graph mechanism 110 provides for a novel technique for facilitating generation of long-form documents using modular LLMs, such as by combining LLMs with dynamically constructed graphs in computing environments.

As aforementioned, in one embodiment, traditional techniques, whether they be monolithic single-prompt generation techniques or rigid form-based systems, are inherently flawed as having and exhibiting severe limitations with respect to scalability, coherence, flexibility, inaccuracy in results, etc.

In contrast, graph mechanism 110, in one embodiment, offers a novel approach that is a graph-based modular system to decompose a document into interconnected sections or nodes such that each section is handled by a specialized LLM agent. This novel technique enables and allows for an incremental generation of documents, while ensuring version control and improved factual consistency and avoiding context-window constraints.

As illustrated, in one embodiment, computing device 120, being part of host organization 101 (e.g., service provider), represents or includes a server computer acting as a host machine for graph mechanism 110 for offering graph-based document generation using modular LLMs.

It is to be noted that terms like “queue message”, “job”, “query”, “request” or simply “message” may be referenced interchangeably and similarly, terms like “job types”, “message types”, “query type”, and “request type” may be referenced interchangeably throughout this document. It is to be further noted that messages may be associated with one or more message types, which may relate to or be associated with one or more customer or client organizations, such as client organizations 121A, 121B, 121N, where, throughout this document, “customer organization”, “client organization”, “customer”, “client”, or simply “organization” may be referenced synonymously and/or interchangeably. An organization, for example, may include or refer to (without limitation) a business (e.g., small business, big business, etc.), a company, a corporation, a non-profit entity, an institution (e.g., educational institution), an agency (e.g., government agency), etc.), etc., serving as a client of host organization 101 (also referred to as “service provider” or simply “host”) serving as a host of graph mechanism 110.

The term “user” may further refer to (without limitation) an end-user associated with one or more of client organizations 121A-N, where the end-user may server as a representative (e.g., individuals or groups owning or working on behalf of one or more of client organizations 121A-N), such as owners, employees, contractors, etc., associated with one or more client organizations 121A-N.

Computing device 120 may include (without limitations) server computers (e.g., cloud server computers, etc.), desktop computers, cluster-based computers, set-top boxes (e.g., Internet-based cable television set-top boxes, etc.), etc. Computing device 120 includes an operating system (“OS”) 106 serving as an interface between one or more hardware/physical resources of computing device 120 and one or more client devices 130A, 130B, 130N, etc. Computing device 120 further includes processor(s) 102, memory 104, input/output (“I/O”) sources 108, such as touchscreens, touch panels, touch pads, virtual or regular keyboards, virtual or regular mice, etc. Client devices 130A-130N may be regarded as external computing devices.

Client devices 130A-N may include (without limitation) organization-based server computers, personal computers, desktop computers, laptop computers, mobile computing devices, such as smartphones, tablet computers, personal digital assistants, e-readers, media Internet devices, smart televisions, television platforms, wearable devices (e.g., glasses, watches, bracelets, smartcards, jewelry, clothing items, etc.), media players, global positioning system-based navigation systems, etc. In some embodiments, client devices 130A-include artificially intelligent devices, such as autonomous machines including (without limitations) one or more of autonomous vehicles, drones, robots, smart household appliances, smart equipment, etc.

In one embodiment, the illustrated database system 150 includes database(s) 140 to store (without limitation) general information, tips, documents, tables, datasets, database records, etc., on behalf of or customized for end-users, client organizations 121A-N, etc. Further, database system 150 is shown to include one or more of underlying hardware, software, and logic elements 145 that implement, for example, database functionality and a code execution environment within host organization 101. In one embodiment, hardware, software, and logic elements 145 of database system 140 may be separate and distinct from client organizations (121A-N) that utilize the services provided by host organization 101 by communicably interfacing between computing device 120 and client devices 130A-N over one or more networks, such as network(s) 135 (e.g., cloud network, the Internet, etc.). This network-based direct communication between computing device 120 and client devices 130A-N allows host organization 101 to offer various subscription services (e.g., document generation, relevant information, document generation tips, access, etc.) to subscribing client organizations 121A-N, while allowing client devices 121A-N to receive subscription services and be able to generate documents using graph mechanism 110. However, embodiments are not limited to subscription and client devices 121A-N, such as, for example, one or more client devices 121A-N may obtain services through a one-time purchase as opposed to a subscription.

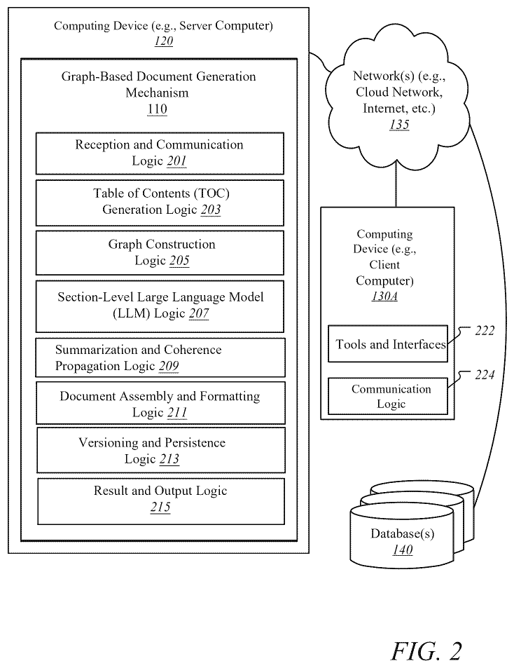

In one embodiment, client devices 130A, 130B, and 130N may be equipped to download and host a software application (such as tools and interfaces 222 of FIG. 2) to allow them to access and use the various graph-based document generation-related features offered by graph mechanism 110. For example, an end-user may perform graph-based document generation via an interface offered by a software application (e.g., tools and interfaces 222 of FIG. 2) using a display screen associated with client device 130A. In communicating with computing device 120 over network 135, requests for various operations may be placed via the software application at client device 130A and received at computing device 120 for processing and similarly, further operations may continue until the end-user, accessing client device 130A, receives the final product, such as a completed document.

It is to be noted that any references to software codes, data, metadata, tables (e.g., custom object table, unified index tables, description tables, etc.), computing devices (e.g., server computers, desktop computers, mobile computers, such as tablet computers, smartphones, etc.), software development languages, software applications, development tools or kits, domains (e.g., Google®, Facebook®, LinkedIn®, etc.), etc., discussed in this document are merely used as examples for brevity, clarity, and ease of understanding and that embodiments are not limited to any particular number or type of data, metadata, tables, computing devices, techniques, programming languages, software applications, software development tools/kits, domains, etc.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “code”, “software code”, “application”, “software application”, “program”, “software program”, “package”, “software code”, “code”, and “software package” may be used interchangeably throughout this document. Moreover, terms like “job”, “input”, “request”, and “message” may be used interchangeably throughout this document.

In this description, numerous specific details are set forth. However, embodiments, as described herein, may be practiced without these specific details. In other instances, well-known circuits, structures and techniques have not been shown in detail in order not to obscure the understanding of this description. It is contemplated that embodiments are not limited to any number or types of processes, materials, apparatus, or techniques for achieving the novel soldering techniques in electronics and semiconductor manufacturing environments.

Throughout this document, terms like “logic”, “component”, “module”, “framework”, “engine”, “mechanism”, “technique”, and/or the like, may be referenced interchangeably and include, by way of example, software, hardware, and/or any combination of software and hardware, such as firmware. Further, any use of a particular brand, word, term, phrase, name, acronym, or the like, such as “device”, “smart device”, “smart”, “circuits”, “electronics”, “semiconductor”, “user”, “end-user”, “material”, “wireless”, “computing device”, “smartphone”, “tablet computer”, “software application”, “social and/or business networking applications or websites”, “website”, or “site”, and/or the like, should not be read to limit embodiments to software or devices that carry that label in products or in literature external to this document.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). Terms like “logic”, “module”, “component”, “engine”, “circuitry”, “element”, and “mechanism” may include, by way of example, software, hardware, firmware, and/or any combination thereof.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

Computing devices 120, 130A, 130B, 130N may host network interface device(s) to provide access to a network, such as a LAN, a wide area network (WAN), a metropolitan area network (MAN), a personal area network (PAN), Bluetooth, a cloud network, a mobile network (e.g., 3^{rd} Generation (3G), 4^{th} Generation (4G), 5^{th} Generation (5G), etc.), an intranet, the Internet, etc. Network interface(s) may include, for example, a wireless network interface having antenna, which may represent one or more antenna (e). Network interface(s) may also include, for example, a wired network interface to communicate with remote devices via network cable, which may be, for example, an Ethernet cable, a coaxial cable, a fiber optic cable, a serial cable, or a parallel cable.

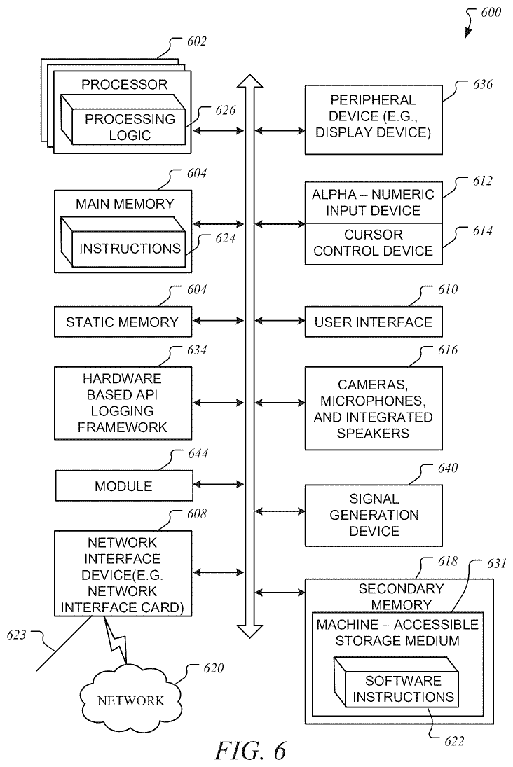

Embodiments may be provided, for example, as a computer program product which may include one or more machine-readable media having stored thereon machine-executable instructions that, when executed by one or more machines such as a computer, a data processing machine, a data processing device, network of computers, or other electronic devices, may result in the one or more machines carrying out operations in accordance with embodiments described herein. As further described with reference to processing architecture 600 of FIG. 6, a machine may include one or more processors, such as a CPU, a GPU, etc. A machine-readable medium may include, but is not limited to, floppy diskettes, optical disks, Compact Disc-Read Only Memories (CD-ROMs), magneto-optical disks, ROMs, Random Access Memories (RAMs), Erasable Programmable Read Only Memories (EPROMs), Electrically Erasable Programmable Read Only Memories (EEPROMs), magnetic or optical cards, flash memory, or other type of media/machine-readable medium suitable for storing machine-executable instructions.

For example, when reading any of the apparatus, method, or system claims of this document to cover a purely software and/or firmware implementation, instructions associated with hemoglobin monitoring mechanism may be expressly stored at a non-transitory computer readable storage device or storage disk such as a memory, a digital versatile disk (DVD), a compact disk (CD), a Blu-ray disk, etc., including the software and/or firmware.

Moreover, one or more elements of hemoglobin monitoring mechanism may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

In some embodiments, terms like “display screen” and “display surface” may be used interchangeably referring to the visible portion of a display device while the rest of the display device may be embedded into a computing device, such as a smartphone, a wearable device, etc. It is contemplated and to be noted that embodiments are not limited to any particular computing device, software application, hardware component, display device, display screen or surface, protocol, standard, etc. For example, embodiments may be applied to and used with any number and type of real-time applications on any number and type of computers, such as desktops, laptops, tablet computers, smartphones, head-mounted displays and other wearable devices, and/or the like. Further, for example, rendering scenarios for efficient performance using this novel technique may range from simple scenarios, such as desktop compositing, to complex scenarios, such as three-dimensional (3D) games, augmented reality applications, etc.

Client computing devices 130A-N may provide a user interface (e.g., graphical user interface (GUI)-based user interface, Web browser, cloud-based platform user interface, software application-based user interface, other user or application programming interfaces (APIs), etc.) as facilitated by interface logic. Computing device 500 may further include I/O source(s) having input component(s), such as camera(s), microphone(s), sensors, detectors, keyboards, mice, etc., and output component(s), such as display device(s) or simply display(s) (e.g., integral displays, tensor displays, projection screens, display screens, etc.), speaker devices(s) or simply speaker(s), etc.

In some embodiments, database(s) 140 may include one or more of storage mediums or devices, repositories, data sources, etc., having any amount and type of information, such as data, metadata, etc., relating to any number and type of applications, such as data and/or metadata relating to one or more users, physical locations or areas, applicable laws, policies and/or regulations, user preferences and/or profiles, security and/or authentication data, historical and/or preferred details, and/or the like.

As aforementioned, terms like “logic”, “module”, “component”, “engine”, “circuitry”, “element”, and “mechanism” may include, by way of example, software, hardware, firmware, and/or any combination thereof.

Client computing devices 130A-N may include I/O source(s) may include any number or type of microphone(s), camera(s), speaker(s), display(s), etc., for capture or presentation of data. For example, one or more microphone(s) may be used to detect speech or sound simultaneously from users, such as speakers. Similarly, one or more camera(s) may be used to capture images or videos of a geographic location (whether that be indoors or outdoors) and its associated contents (e.g., furniture, electronic devices, humans, animals, trees, mountains, etc.) and form a set of images or video streams.

Moreover, input component(s) of client computing devices 130A-N may include any number or type of cameras, such as depth-sensing cameras or capturing devices that are known for capturing still and/or video red-green-blue (RGB) and/or RGB-depth (RGB-D) images for media, such as personal media. Such images, having depth information, have been effectively used for various computer vision and computational photography effects, such as (without limitations) scene understanding, refocusing, composition, cinema-graphs, etc. Similarly, for example, displays may include any number and type of displays, such as integral displays, tensor displays, stereoscopic displays, etc., including (but not limited to) embedded or connected display screens, display devices, projectors, etc.

Input component(s) of client computing devices 130A-N may further include one or more of vibration components, tactile components, conductance elements, biometric sensors, chemical detectors, signal detectors, electroencephalography, functional near-infrared spectroscopy, wave detectors, force sensors (e.g., accelerometers), illuminators, eye-tracking or gaze-tracking system, head-tracking system, etc., that may be used for capturing any amount and type of visual data, such as images (e.g., photos, videos, movies, audio/video streams, etc.), and non-visual data, such as audio streams or signals (e.g., sound, noise, vibration, ultrasound, etc.), radio waves (e.g., wireless signals, such as wireless signals having data, metadata, signs, etc.), chemical changes or properties (e.g., humidity, body temperature, etc.), biometric readings (e.g., figure prints, etc.), brainwaves, brain circulation, environmental/weather conditions, maps, etc. It is contemplated that “sensor” and “detector” may be referenced interchangeably throughout this document. It is further contemplated that one or more input component(s) may further include one or more of supporting or supplemental devices for capturing and/or sensing of data, such as illuminators (e.g., IR illuminator), light fixtures, generators, sound blockers, etc.

It is further contemplated that in one embodiment, input component(s) of client computing devices 130A-M may include any number and type of context sensors (e.g., linear accelerometer) for sensing or detecting any number and type of contexts (e.g., estimating horizon, linear acceleration, etc., relating to a mobile computing device, etc.). For example, input component(s) may include any number and type of sensors, such as (without limitations): accelerometers (e.g., linear accelerometer to measure linear acceleration, etc.); inertial devices (e.g., inertial accelerometers, inertial gyroscopes, micro-electro-mechanical systems (MEMS) gyroscopes, inertial navigators, etc.); and gravity gradiometers to study and measure variations in gravitation acceleration due to gravity, etc.

Similarly, output component(s) of client computing devices 130A-N may include any number and type of speaker(s) or speaker device(s) to serve as output devices for outputting or giving out audio for any number or type of reasons, such as human hearing or consumption. For example, speaker(s) work the opposite of microphone(s) where speaker(s) convert electric signals into sound.

Further, output component(s) of client computing devices 130A-N may include dynamic tactile touch screens having tactile effectors as an example of presenting visualization of touch, where an embodiment of such may be ultrasonic generators that can send signals in space which, when reaching, for example, human fingers can cause tactile sensation or like feeling on the fingers. Further, for example and in one embodiment, output component(s) may include (without limitation) one or more of light sources, display devices and/or screens, audio speakers, tactile components, conductance elements, bone conducting speakers, olfactory or smell visual and/or non/visual presentation devices, haptic or touch visual and/or non-visual presentation devices, animation display devices, biometric display devices, X-ray display devices, high-resolution displays, high-dynamic range displays, multi-view displays, and head-mounted displays (HMDs) for at least one of virtual reality (VR) and augmented reality (AR), etc.

FIG. 2 illustrates graph-based document generation mechanism 110 of FIG. 1 according to one embodiment. In one embodiment, graph mechanism 110 provides for a novel technique for facilitating generation of long-form documents using modular LLMs, such as by combining LLMs with dynamically constructed graphs in computing environments. In one embodiment, graph mechanism 110 may include any number and type of components, such as reception and communication logic 201, Table of Contents (TOC) generation logic 203, graph construction logic 205, section-level LLM logic 207, summarization and coherence propagation logic 209, document assembly and formatting logic 211, versioning and persistence logic 213, and result and output logic 215. In another embodiment, there may not be any use for server computing device 120 such that graph mechanism 110 (having all the necessary components, such as components 201-215) may be downloaded on client computing device 130A for performing any relevant operations locally and therefore eliminating the need for communicating with or having server computing device 120. For example, tools and interfaces 222 at client device 130A may include or be replaced with graph mechanism 110.

In one embodiment, computing device 120 may serve as a service provider for graph mechanism 110 and be in communication with one or more database(s) 140, client computer 130A, over one or more networks 135, and any number and type of dedicated nodes. In one embodiment, one or more databases 140 may be used to host, hold, or store data including interface details, API documentation, tool information, menus, objects, tables, code samples, client data, organization data, messages, queries, etc.

As will be further described in this document, computing device 120 serves a service provider to support tools and interfaces 222 (e.g., downloaded or cloud-based software application) at client device 130A for facilitating graph-based document generation at client device 130A over one or more networks 135 (e.g., cloud network, Internet, etc.). In communication with server computing device 120, tools and interfaces 222 at client computing device 130A allow an end-user to place queries, access information, generate documents, receive completed documents as results, etc. In one embodiment, reception and communication logic 201 and communication logic 224 allow for communication between computing device 120 and client device 130A over one or more networks 135.

Throughout this document, terms like “framework”, “mechanism”, “engine”, “logic”, “component”, “module”, “tool”, “builder”, “circuit”, and “circuitry”, may be referenced interchangeably and include, by way of example, software, hardware, firmware, or any combination thereof. Further, any use of a particular brand, word, or term, such as “graph”, “graph-based”, “document”, “document generation” “LLM”, “query”, “data”, “user data”, “searching”, “similar”, “similarity”, “not similar”, “likelihood”, “predicting”, “similarity score”, “relevance”, “calculating”, “comparing”, “ranking”, “sorting”, “communicating”, “presenting”, “user interface”, “code”, “metadata”, “software application”, “database servers”, “metadata”, “database”, etc., should not be read to limit embodiments to software or devices that carry that label in products or in literature external to this document.

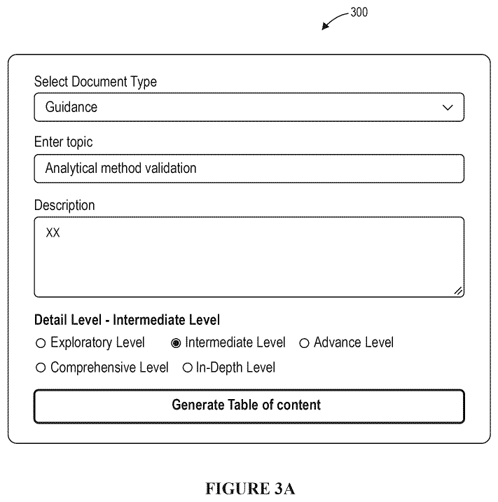

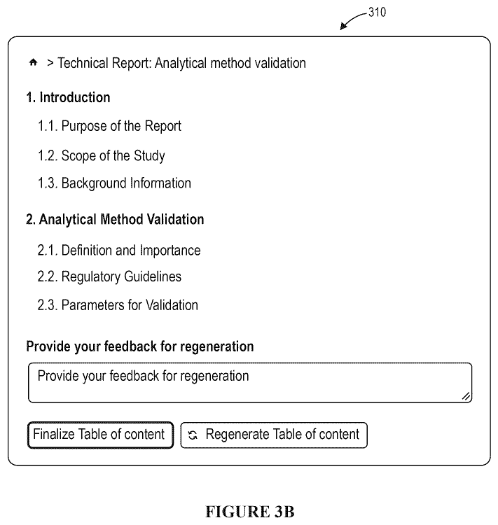

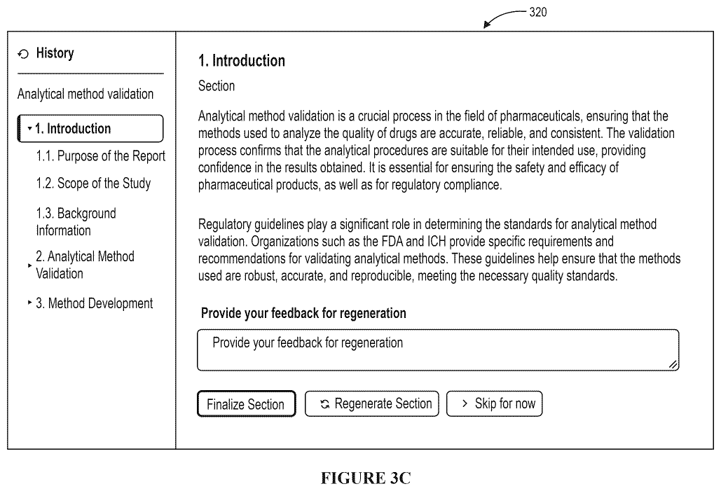

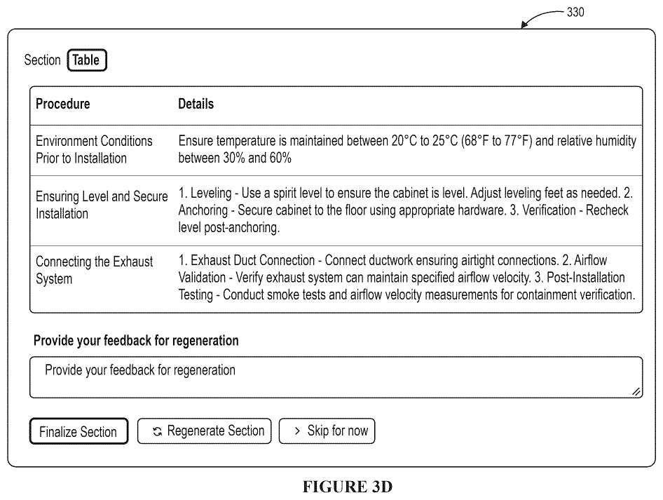

In one embodiment, using TOC generation logic 203, a specialized LLM agent proposes an initial TOC based on the user's topic or area of interest, input guidance, and any retrieved context, based on retrieval-augmented generation (RAG), as received by reception and communication logic 201 and then evaluated or analyzed by TOC generation logic 203 as illustrated in FIGS. 3A-3B. In this case, the user can interactively refine the TOC and once approved through TOC generation logic 203, each headline becomes a node in the graph.

Continuing with graph mechanism 110, in one embodiment, graph construction logic 205 is triggered to convert the finalized TOC into a graph data structure, where each node represents a document section and edges define parent-child relationships. Further, graph construction logic 205 attaches metadata (e.g., desired word count, model type, priority, etc.) to the document and determines its execution order via typological sorting.

In one embodiment, graph mechanism 110 further hosts section-level LLM logic 207 to assign any nodes to a specialized LLM (or fine-tuned model) optimized for a specific document section's purpose (e.g., introduction, related work, methodology, etc.). The prompt for each node includes one or more of a) section title and instructions (e.g., tone, length, etc.), b) retrieved snippets from a vector database (based on RAG) to ground factual content, and c) summaries of parent nodes to maintain coherence. This is further illustrated with reference to FIGS. 3C-3D.

Graph mechanism 110 further includes summarization and coherence propagation logic 209 to facilitate a summarization agent to produce a concise synopsis (e.g., 3-5 bullet points, 100 words, etc.) after a node generates its draft text according to one embodiment. These summaries propagate along graph edges, informing downstream nodes, where, if contradictions arise, summarization and coherence propagation logic 209 flags sections for review. In one embodiment, graph mechanism 110 further includes document assembly and formatting logic 211 to, once the nodes complete generation, facilitate an assembly agent to traverse the graph in TOC order, concatenate section texts, map numbered headings, resolve cross-references, and apply a user-defined template (e.g., Markdown®, LaTex®, Word®, etc.). Further, tables, figures, code snippets, etc., are anchored at designated placeholders such that a final proofreading pass (such as by a grammar/style LLM), as facilitated by document assembly and formatting logic 211, ensures overall consistency.

Further with respect to graph mechanism 110, it includes versioning and persistence logic 213 to, in one embodiment, facilitate storing of each node's raw output, summary, and metadata (e.g., timestamp, model version, prompt hash, etc.) as discrete artifacts. In one embodiment, graph snapshots can be captured at key milestones (such as after TOC approval, midway through section generation, post-assembly, etc.). Moreover, users can roll back individual sections to prior versions without affecting unrelated nodes, where, if a parent node changes, the dependent child nodes are marked “stale” for re-generation.

Finally, in one embodiment, graph mechanism 110 includes result compilation and output logic 215 to compile the results and facilitate their output, such as compiling and finalizing the final document and facilitating the output (e.g., final document) to be communicated via reception and communication logic 201 and communication logic 224 to be displayed at a display screen via tools and interfaces 222 at client device 130A.

In some embodiments, various components 201-215 of graph mechanism 110 further incorporate one or more components, such as orchestration logic, LLM integration logic, LLM provider logic, vector search logic (based on RAG), structured data storage, user interface logic, version control logic, etc. For example, the orchestration logic (based on Python™, Flask™, etc.) may be used for coordinating workflow, expose application programming interface (API) endpoints for user interfaces (UIs) and agents, etc. Similarly, the LLM integration logic (based on LangChain™, LangGraph™, etc.) may be used to facilitate management of structured prompts, chaining, and memory, while the LLM provider logic (based on OpenAI or equivalent) may be used to facilitate generation of core models for TOC, section drafting, summarization, proofreading, etc.

Further, in one embodiment, the vector search logic (based on one or more databases such as (but not limited to) PostgreSQL™, pgvector extension, etc.) may be used to facilitate storing embeddings and performing similarity searches for RAG, while the structured data storage (based on one or more databases such as (but not limited to) PostgreSQL™, etc.) to facilitate persisting TOC, node metadata, summaries, versions, and graph snapshots, etc. In one embodiment, user interface logic (based on Angular™) to allow for users to input their guidance, refine TOC, review/edit sections, and trigger updates, while version control logic (based on Git-like backend or custom storage) records discrete versions of each section, support rollbacks, and different visualizations, etc.

In one embodiment, the graph-based document generation technique as facilitated by graph mechanism 110 allows for scalability, reduced hallucinations and improved coherence, fine-grained control, token-size independence, versioning and auditability, dynamic granularity, and/or cost efficiency, etc. For example, with respect to scalability, graph mechanism 110 allows splitting of a document into smaller nodes, where no single prompt exceeds an LLM's context window, while parallel processing reduces generation time. Similarly, graph mechanism 110 further offers RAG to keep each node grounded in factual context, while summaries serve as checkpoints and contradictions between nodes are flagged before the final assembly, which leads to reduced hallucinations and improved coherence.

With respect to fine-grained control, in one embodiment, graph mechanism 110 allows users to adjust style, tone, length, and/or content of each section independently, where specialized LLMs (or fine-tuned versions) can be assigned to particular section types (e.g., methodology, conclusion, etc.), ensuring consistency with domain conventions. Similarly, token-size independence is achieved through graph mechanism 110 setting no hard limit on overall document length, where each node's generation remains within the context window, allowing for even exceedingly long and detailed documents (such as multi-chapter reports, regulatory filings, academic theses, etc.).

Furthermore, versioning and auditability is achieved with section-level version control allowing precise rollbacks without regenerating entire documents, and metadata (e.g., timestamps, prompt hashes, model versions, etc.) enabling full audit trails that could be crucial for legal documents, regulatory reports, and/or patent applications, etc., as facilitated by graph mechanism 110.

Graph mechanism 110 further allows for nodes to be merged or split on the fly based on user feedback or content needs and that a TOC can start at a high level and be refined later into more detailed sub-sections, as necessitated, resulting in dynamic granularity according to one embodiment. Another feature being cost efficiency is achieved with graph mechanism 110 allowing for smaller, task-specific LLMs (or distilled models) to handle simple sections, while allowing larger models to focus on complex reasoning for optimizing computational resources. Further, parallel execution avoids repeating training or reinvoking a large LLM on an entire document for minor edits that results in cost efficiency according to one embodiment.

This novel technique for graph-based document generation using graph mechanism 110 is preferred over conventional techniques for context window limits, hallucinations, edit flexibility, real-time preview, granularity control, versioning/auditability, and/or parallel collaboration, etc. For example, with respect to context window limits, the novel technique as facilitated by graph mechanism 110 allows for each node to file within its context while parent to summarize and maintain coherence. Further, this novel technique for graph-based document generation provides for low hallucinations through RAG plus summarization checkpoints to keep nodes grounded and consistent, while providing high edit flexibility through updating of single nodes, down-streaming of nodes flagged “stale” and regenerating selectively.

In one embodiment, the novel technique for graph-based document generation as facilitated by graph mechanism 110 offers high real-time preview such that users can review and edit each node's draft and summary, if any, before assembling the document, while providing fine granularity by allowing the nodes to split or merge dynamically and the user to have the option of choose their own detail level regarding content of the document.

This novel technique for graph-based document generation as facilitated by graph mechanism 110 is further preferred over any conventional techniques for providing extensive versioning and auditability, where each node is versioned with metadata, full audit trail, and/or rollback capability, etc. The novel technique also offers native parallel collaboration such that nodes can be generated in parallel, while multiple authors and/or agents can simultaneously work on different sections of a single document.

In one embodiment, when installing a biosafety cabinet, it might be desired to assess specific environmental conditions to ensure that the cabinet operates efficiently and complies with regulatory standards. For example, a proper evaluation of an installation site can help mitigate risks associated with environmental factors that could impact the performance of the cabinet and overall biosafety.

The aforementioned specific environmental conditions may include one or more of a) airflow patterns to evaluate the airflow in a room to ensure that there are no drafts or turbulence that could disrupt the cabinet's airflow dynamics, and/or b) room size and layout to ensure that the room is adequately sized for the biosafety cabinet and that there is sufficient space around it for proper operations and maintenance.

Further, when installing a biosafety cabinet, it might be desirable to ensure that specific environment necessities are met to maintain optimal performance and safety, where these necessities are based on one or more factors, such as temperature, humidity, airflow, etc., which can play a significant role in the functionality of the cabinet.

The aforementioned, specific environmental necessities may include a) temperature, where it is to ensure that the installation room maintains a temperature range that is conducive to any operations associated with the biosafety cabinet, ideally between 18 C (64 F) to 27 C (80 F), and b) humidity, where relative humidity levels are controlled and generally kept between 40% and 60% to prevent condensation and ensure the effectiveness of the filtration system.

Reception and communication logic 201 is capable of dynamically communicating and maintaining compatibility with any number and type of software/application development tools, models, data processing servers, database platforms and architectures, programming languages and their corresponding platforms, etc., while ensuring compatibility with changing technologies, parameters, protocols, standards, etc.

It is contemplated that any number and type of components may be added to and/or removed from graph mechanism 110 to facilitate various embodiments including adding, removing, and/or enhancing certain features. It is contemplated that embodiments are not limited to any technology, topology, system, architecture, and/or standard and are dynamic enough to adapt to any future changes.

FIGS. 3A and 3B are screengrabs 300 and 310, respectively, illustrating features of TOC generation logic 203 of FIG. 2 according to one embodiment. It is to be noted that for brevity, clarity, and ease of understanding, many of the components and processes described with respect to FIGS. 3A-3B may not be repeated or discussed hereafter. As illustrated in FIG. 3A, screengrab 300 illustrates a drop-down menu for selecting document type (e.g., guidance) and a blank space for entering guidance topic (e.g., analytical method validation) and another one to enter any relevant description of the documents to be generated. Screengrab 300 further illustrates detail levels, ranging from the exploratory level to the in-depth level, and finally a button or bar is provided to click to generate a TOC according to one embodiment.

FIG. 3B illustrates another screengrab 310, the user can interactively refine or modify the TOC and once approved, each headline associated with the TOC turns into a node in the graph. For example, as illustrated in screengrab 310 of FIG. 3B, a list of headlines are offered as part of a technical report along with a space for the user to provide any feedback for regeneration of the TOC and a button or bar to finalize the TOC.

FIGS. 3C and 3D are screengrabs 320 and 330, respectively, illustrating features of section-level LLM logic 207 of FIG. 2 according to one embodiment. It is to be noted that for brevity, clarity, and ease of understanding, many of the components and processes described with respect to FIGS. 3C-3D may not be repeated or discussed hereafter. As illustrated in FIG. 3C, screengrab 320 shows a list of headlines and sections for each node, such as section title and instructions (e.g., tone, length), retrieved snippets from a vector database (based on RAG) to ground factual content, summaries of parent nodes to maintain coherence, etc. As illustrated in screengrab 320, an introduction and various headlines are listed for the analytical method validation node along with some space for the user feedback regarding regeneration and a few buttons representing finalize section, regenerate section, skip for now, etc.

Similarly, screengrab 330 of FIG. 3D illustrates a table having two columns representing procedures and details associated with each procedure, such as a procedure associated with environment conditions prior to installation, and details relating to that procedure. Screengrab 330 further provides some space for the user's feedback regarding regeneration and a few buttons representing finalize section, regenerate section, skip for now, etc.

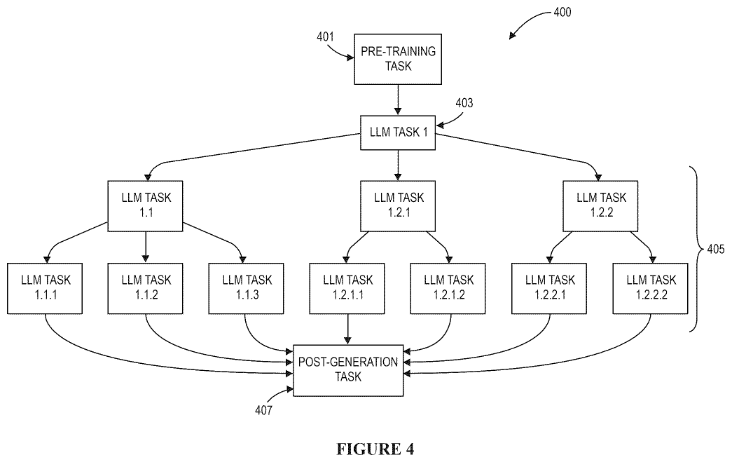

FIG. 4 illustrates a transaction sequence 400 for facilitating document generation in a computing environment based on graph mechanism 110 of FIG. 1 according to one embodiment. Transaction sequence 400 may be performed by processing logic that may comprise hardware (e.g., circuitry, dedicated logic, programmable logic, etc.), software (such as instructions run on a processing device), or a combination thereof. In one embodiment, transaction sequence 400 may be performed or facilitated by one or more components of graph mechanism 110 of FIG. 2. The transactions or processes of transaction sequence 400 are illustrated in linear sequences for brevity and clarity in presentation; however, it is contemplated that any number of them can be performed in parallel, asynchronously, or in different orders. Further, for brevity, clarity, and ease of understanding, many of the components and transactions described with respect to FIGS. 1-3D may not be repeated or discussed hereafter.

The illustrated transaction sequence 400 shows a process for document generation that starts with a pre-generation task of 401 that can be used to initially define a graph of a document that is to be generated. In one embodiment, this pre-generation task of 401 includes generating a TOC, where a user provides inputs, like document type, and guidance with respect to the document to be generated. In some embodiments, there may be several discretionary options available to the user to further refine or modify the document.

In one embodiment, minimal details might be used to get started with pre-generation task of 401 to generate the TOC associated with the document and subsequently, to start generating the graph based on the TOC and perform LLM tasks at 403 to assign specific LLM capabilities for each section of the document at 405. At 407, post-generation tasks are initiated to finalize the generated document.

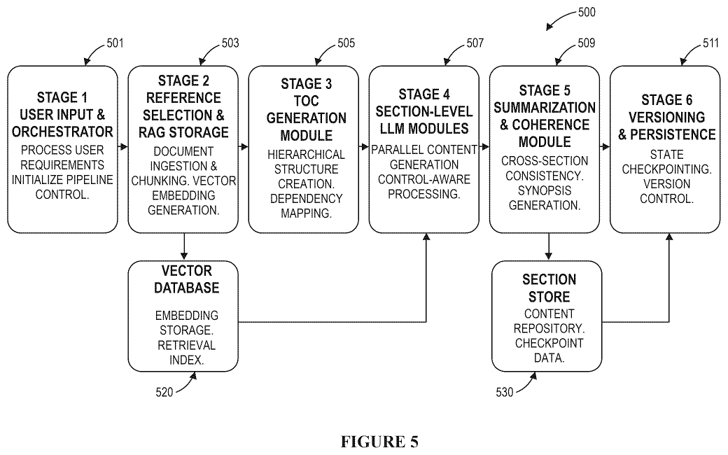

FIG. 5 illustrates a method 500 for facilitating document generation in a computing environment based on graph mechanism 110 of FIG. 1 according to one embodiment. Method 500 may be performed by processing logic that may comprise hardware (e.g., circuitry, dedicated logic, programmable logic, etc.), software (such as instructions run on a processing device), or a combination thereof. In one embodiment, method 500 may be performed or facilitated by one or more components of graph mechanism 110 of FIG. 2. The transactions or processes of method 500 are illustrated in linear sequences for brevity and clarity in presentation; however, it is contemplated that any number of them can be performed in parallel, asynchronously, or in different orders. Further, for brevity, clarity, and ease of understanding, many of the components and transactions described with respect to FIGS. 1-4 may not be repeated or discussed hereafter.

In one embodiment, method 500 begins with user input and orchestrator at 501, where inputs or requests from a user are used to initiate pipeline control. Method 500 continues with reference selection and RAG storage at 503, where the user-provided or externally sources documents (e.g., data, metadata, articles, etc.) are integrated for vector embedding operations using chunked and embedded documents from vector database 520 (e.g., Facebook® AI Similarity Search (FAISS®), pgvector, etc.) that serves as an embedding storage for retrieval index. In this process of reference ingestion and RAG setup, during section generation, each node's prompt includes relevant retrieved snippets, reducing hallucinations.

In one embodiment, method 500 continues with TOC (outline) generation at 505 that leads to hierarchical structure creation dependency mapping, such as where a TOC agent receives the user's topic and any retrieved context, generates a hierarchical outline of sections and subsections, etc. Further, the user is allowed to edit, rearrange, split, and/or merge headlines, and once the TOC is finalized, the TOC is used to define the node set for the graph.

In one embodiment, TOC generation at 505 further leads to dynamic construction of the graph, where each TOC entry associates graph notes with metadata (e.g., expected length, priority, model type, etc.), constructs parent-child relationships from directed edges, and determines a generation order (e.g., parents before children) based on a topological sort.

At 507, selection-level generation is performed for parallel content generation based on context-aware processing. In one embodiment, for a node, the retrieved documents/snippets relevant to a section associated with the node is collected from vector database 520 and any summaries associated with the parent node, if any, are gathered. Further, a focused prompt (such as “using the following referenced material and the summary of Section 1, write a 500-word Methods section with a formal tone”) is crafted, while a specialized LLM agent is triggered to draft the section. A summarization agent extracts a brief summary of the drafted text.

At 509, summarization and consistency checks are triggered to facilitate generation of cross-section consistency and synopsis based on content repository and checkpoint data at section store 530 according to one embodiment. In one embodiment, summarization and consistency checks at 509 is further to propagate summaries to children, such as “if Section 1 says YouTube insights, Section is not to contradict it”. Further, automated consistency checks compare key terms or facts across summaries, while if inconsistencies are detected, the system flags one or more nodes for user review for re-generation.

In one embodiment, summarization and consistency checks at 509 further continues with parallelization and collaboration including processing independent nodes in parallel, subject to their dependency order (e.g., parent first, followed by oldest child, etc.). Further, multiple users or LLM agents can collaborate by editing node prompts, updating RAG sources, or reviewing drafts. In one embodiment, method 500 continues with document assembly where after the nodes have been generated, the assembly agent traverses the graph in TOC order, concatenates section texts with appropriate numbering (e.g., 1, 1.1, 1.2, etc.), resolves in-text references (e.g., “see Section 3.2”, etc.), applies user-selected formatting (e.g., styles, fonts, margins, templates, etc.), and/or optionally invokes a final LLM pass for grammar/format polishing, etc.

Method 500, in one embodiment, continues with versioning and persistence at 511 with stale checkpointing version control. For example, each node's outputs, prompt logs, and/or summaries, etc., are stored at section store 530 such that users can view the history of any specific section, compare revisions, and/or revert back to any prior version, etc. For example, if Section 1 is edited, the dependent child nodes (e.g., 1.1, 1.2, etc.) are automatically marked “stale”, where the user chooses whether to regenerate any of the sections either immediately or defer to a later stage of time.

In one embodiment, document generation is performed via an orchestrator logic, where references are retrieved using a RAG approach, where the reference may be stored at or retrieved from one or more databases, such as vector database 520. In one embodiment, a hierarchical TOC comprising multiple section headings is generated, where a graph is constructed, the graph having nodes corresponding to TOC headings associated with sections and/or graph edges representing section dependencies. Further, each node is assigned to a specialized section-level LLM to generate complete content for the document using one or more of retrieved references, section contents, and/or contexts associated with connected nodes. In one embodiment, generated sections are summarized, while the summaries are propagated along the graph edges to prepare information to be used for generation of subsequent documents. In one embodiment, a final version of the document is assembled or generated by concatenating section contents or texts and applying a user-defined formatting template. Further, section contents are interactively refined based on summary propagation and user feedback.

In one embodiment, the orchestrator aspect of the graph mechanism 110 of FIG. 1 can split or merge section nodes in response to user edits or evolving content requirements, dynamically reconfiguring the graph structure, etc. Further, multiple versions of each node's content (e.g., raw output, summaries, prompt logs, timestamps, and model versions, are recorded, and rolling back of one or more section nodes is enabled to one or more prior versions without affecting other nodes. Embodiments further provide for one or more interfaces that allow one or more users to review and edit the generated TOC before graph assembly or generation, where a directed graph is constructed based on the user-edited TOC.

Further, in one embodiment, each node is handled by the LLM fine-tuned or configured according to section types (e.g., introduction, methodology, conclusion, etc.), and generation of different nodes in different languages are enabled, if desired. The document assembly applies a user-defined template (e.g., Markdown, LaTeX, Word®, etc.) to each section and to the assembled document, producing a polished final output of the document.

By decomposing a long-form writing task into a directed graph of interconnected nodes, where each node is handled by a specialized LLM agent and grounded in retrieval-augmented context, this novel technique for graph-based document generation overcomes any shortcomings of monolithic and template-driven approaches. This novel technique allows for scalability so the sections do not exceed the LLM's context window and nodes can be generated in parallel, and offers coherence for summaries and RAG grounding reducing hallucinations while maintaining topic alignment.

Further, this novel technique offers flexibility so the users can review and/or edit individual sections on the fly, dynamically restructure the graph, and apply fine-grained styling, etc. Embodiments further provide for efficiency through specialized (and potentially smaller) LLMs to handle simple sections, while larger models tackle complex reasoning and reduce computational costs. Additionally, version control and auditability is offered through section-level versioning, prompt hashing, and metadata enable precise rollbacks and full audit trails that might be important for legal documents, regulatory files, academic workflows, etc.

For example, a modular pipeline may be well-suited for generating academic manuscripts, whitepapers, patent applications, compliance reports, multi-lingual manuals, etc. Additional features may include automated agent-based critique loops, quality-metric-driven graph restructuring, and deeper integration with enterprise knowledge graphs. This methodology and novel technique paves the way for next-generation artificial intelligence (AI)-assisted authorizing tools that combine structured outlines with LLM prowess.

FIG. 6 illustrates a diagrammatic representation of a machine 600 in the exemplary form of a computer system, in accordance with one embodiment, within which a set of instructions, for causing machine 600 to perform any one or more of the methodologies discussed herein, may be executed. Machine or computing device 600 employed by smart non-invasive hemoglobin monitoring device may be the same as or similar to or contained within or include smart non-invasive hemoglobin monitoring mechanism to perform or execute one or more methodologies discussed throughout this document. In alternative embodiments, computing device 600 may be connected (e.g., networked) to other machines either directly, such as via media slot or over a network, such as a cloud-based network, a Local Area Network (LAN), a Wide Area Network (WAN), a Metropolitan Area Network (MAN), a Personal Area Network (PAN), an intranet, an extranet, or the Internet. The machine may operate in the capacity of a server or a client machine in a client-server network environment, or as a peer-machine in a peer-to-peer (or distributed) network environment or as a server or series of servers within an on-demand service environment, including an on-demand environment providing multi-tenant database storage services. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

Computing device 600 includes one or more processors 602, a main memory 604 (e.g., read-only memory (ROM), flash memory, dynamic random access memory (DRAM) such as synchronous DRAM (SDRAM) or Rambus DRAM (RDRAM), etc., static memory 642, such as flash memory, static random access memory (SRAM), volatile but high-data rate RAM, etc.), and a secondary memory 618 (e.g., a persistent storage device including hard disk drives and persistent multi-tenant data base implementations), which communicate with each other via a bus 630. Main memory 604 includes instructions 624 (such as software 622 on which is stored one or more sets of instructions 624 embodying any one or more of the methodologies or functions of smart non-invasive hemoglobin monitoring mechanism at smart non-invasive hemoglobin monitoring device and other figures described herein) which operate in conjunction with processing logic 626 and processor 602 to perform the methodologies discussed herein.

Processor 602 represents one or more general-purpose processing devices such as a microprocessor, central processing unit, or the like. More particularly, the processor 602 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 602 may also be one or more special-purpose processing devices such as an application specific integrated circuit (ASIC), a field programmable gate array (FPGA), a digital signal processor (DSP), network processor, or the like. Processor 602 is configured to execute the processing logic 626 for performing the operations and functionality of smart non-invasive hemoglobin monitoring mechanism/device and other figures discussed herein.

Computing device 600 may further include a network interface device 608, such as a network interface card (NIC). Computing device 600 also may include a user interface 610 (such as a video display unit, a liquid crystal display (LCD), or a cathode ray tube (CRT)), an alphanumeric input device 612 (e.g., a keyboard), a cursor control device 614 (e.g., a mouse), a signal generation device 640 (e.g., an integrated speaker), and other devices 616 like cameras, microphones, integrated speakers, etc. Computing device 600 may further include peripheral device 636 (e.g., wireless or wired communication devices, memory devices, storage devices, audio processing devices, video processing devices, display devices, etc.). Computing device 600 may further include a hardware-based application programming interface logging framework 634 capable of executing incoming requests for services and emitting execution data responsive to the fulfillment of such incoming requests.

Network interface device 608 may also include, for example, a wired network interface to communicate with remote devices via network cable 623, which may be, for example, an Ethernet cable, a coaxial cable, a fiber optic cable, a serial cable, a parallel cable, etc. Network interface device 608 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported. In addition to, or instead of, communication via the wireless LAN standards, network interface device 608 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

The secondary memory 618 may include a machine-readable storage medium (or more specifically a machine-accessible storage medium) 631 on which is stored one or more sets of instructions (e.g., software 622) embodying any one or more of the methodologies or functions of smart non-invasive hemoglobin monitoring mechanism/device and other figures described herein. Software 622 may also reside, completely or at least partially, within the main memory 604, such as instructions 624, and/or within the processor 602 during execution thereof by the computer system 600, the main memory 604 and the processor 602 also constituting machine-readable storage media. Software 622 may further be transmitted or received over network 620 via the network interface card 608. Machine-readable storage medium 631 may include transitory or non-transitory machine-readable storage media.

Portions of various embodiments may be provided as a computer program product, which may include a computer-readable medium having stored thereon computer program instructions, which may be used to program a computer (or other electronic devices) to perform a process according to the embodiments. The machine-readable medium may include, but is not limited to, floppy diskettes, optical disks, compact disk read-only memory (CD-ROM), and magneto-optical disks, ROM, RAM, erasable programmable read-only memory (EPROM), electrically EPROM (EEPROM), magnet or optical cards, flash memory, or other type of media/machine-readable medium suitable for storing electronic instructions.

Modules 644 relating to and/or include components and other features described herein (for example in relation to smart non-invasive hemoglobin monitoring mechanism at smart non-invasive hemoglobin monitoring device) can be implemented as discrete hardware components or integrated in the functionality of hardware components such as ASICS, FPGAs, DSPs or similar devices. In addition, modules 644 can be implemented as firmware or functional circuitry within hardware devices. Further, modules 644 can be implemented in any combination of hardware devices and/or software components.

The techniques shown in the figures can be implemented using code and data stored and executed on one or more electronic devices (e.g., an end station, a network element). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more buses and bridges (also termed as bus controllers). Thus, the storage device of a given electronic device typically stores code and/or data for execution on the set of one or more processors of that electronic device. Of course, one or more parts of an embodiment may be implemented using different combinations of software, firmware, and/or hardware.

Any of the above embodiments may be used alone or together with one another in any combination. Embodiments encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the embodiments are not limited to the implementations described and can be practiced with modification and alteration within the spirit and scope of the appended claims. The description is thus illustrative instead of limiting.

In the detailed description, references are made to the accompanying drawings, which form a part of the description and in which are shown, by way of illustration, specific implementations. Although these disclosed implementations are described in sufficient detail to enable one skilled in the art to practice the implementations, it is to be understood that these examples are not limiting, such that other implementations may be used, and changes may be made to the disclosed implementations without departing from their spirit and scope. For example, the blocks of the methods shown and described herein are not necessarily performed in the order indicated in some other implementations. Additionally, in some other implementations, the disclosed methods may include more or fewer blocks than are described. As another example, some blocks described herein as separate blocks may be combined in some other implementations. Conversely, what may be described herein as a single block may be implemented in multiple blocks in some other implementations. Additionally, the conjunction “or” is intended herein in the inclusive sense where appropriate unless otherwise indicated; that is, the phrase “A, B, or C” is intended to include the possibilities of “A,” “B,” “C,” “A and B,” “B and C,” “A and C,” and “A, B, and C.”

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion.

In addition, the articles “a” and “an” as used herein and in the appended claims should generally be construed to mean “one or more” unless specified otherwise or clear from context to be directed to a singular form. Reference throughout this specification to “an implementation,” “one implementation,” “some implementations,” or “certain implementations” indicates that a particular feature, structure, or characteristic described in connection with the implementation is included in at least one implementation. Thus, the appearances of the phrase “an implementation,” “one implementation,” “some implementations,” or “certain implementations” in various locations throughout this Specification are not necessarily all referring to the same implementation.

Some portions of the detailed description may be presented in terms of algorithms and symbolic representations of operations on data bits within a computer memory. These algorithmic descriptions and representations are the manner used by those skilled in the data processing arts to convey the substance of their work to others skilled in the art. An algorithm is herein, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, or otherwise manipulated. It has proven convenient at times, principally for reasons of common usage, to refer to these signals as bits, values, elements, symbols, characters, terms, numbers, or the like.

It should also be understood that some of the disclosed implementations can be embodied in the form of various types of hardware, software, firmware, or combinations thereof, including in the form of control logic, and using such hardware or software in a modular or integrated manner. Other methods or techniques are feasible using hardware and a combination of hardware and software. Any of the software components or functions described in this application can be implemented as software code to be executed by one or more processors using any suitable computer language such as, for example, C, C++, Java™, or Python using, for example, existing or object-oriented techniques. The software code can be stored as non-transitory instructions on any type of tangible computer-readable storage medium (referred to herein as a “non-transitory computer-readable storage medium”). Examples of suitable media include random access memory (RAM), read-only memory (ROM), magnetic media such as a hard-drive or a floppy disk, or an optical medium such as a compact disc (CD) or digital versatile disc (DVD), flash memory, and the like, or any combination of such storage or transmission devices. Computer-readable media encoded with the software/program code may be packaged with a compatible device or provided separately from other devices (for example, via Internet download). Any such computer-readable medium may reside on or within a single computing device or an entire computer system and may be among other computer-readable media within a system or network. A computer system, or other computing device, may include a monitor, printer, or other suitable display for providing any of the results mentioned herein to a user.

In the foregoing description, numerous details are set forth. It will be apparent, however, to one of ordinary skills in the art having the benefit of this disclosure, that the present disclosure may be practiced without these specific details. While specific implementations have been described herein, it should be understood that they have been presented by way of example only, and not limitation. The breadth and scope of the present application should not be limited by any of the implementations described herein but should be defined only in accordance with the following and later-submitted claims and their equivalents. Indeed, other various implementations of and modifications to the present disclosure, in addition to those described herein, will be apparent to those of ordinary skill in the art from the foregoing description and accompanying drawings. Thus, such other implementations and modifications are intended to fall within the scope of the present disclosure.

Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein, along with the full scope of equivalents to which such claims are entitled.

Any of the above embodiments may be used alone or together with one another in any combination. Embodiments encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive.

What is claimed is:

1. At least one computer-readable medium having stored thereon instructions which, when executed, cause a computing device to perform operations comprising:
generating a hierarchical table of contents (TOC) having section headings relating to a document to be assembled;
constructing a graph having nodes corresponding to one or more of section headings associated with sections and graph edges corresponding to section dependencies associated with the section headings; and
assembling the document by concatenating section contents corresponding to the section headings based on a user-defined formatting template.

2. The computer-readable medium of claim 1, wherein the operations further comprise:
retrieving references for the document based on a retrieval-augmented generation (RAG), wherein the references are retrieved from one or more databases coupled to the computing device; and
assigning one or more of the nodes to a specialized section-level large language model (LLM) to facilitate generating complete content for the document based on one or more of the retrieved references, the section contents, or context from the nodes.

3. The computer-readable medium of claim 1, wherein the operations further comprise:
summarizing the sections and propagating the summarized sections along the graph edges to prepare information to be used for generating subsequent documents; and
interactively refining the section contents based on summary propagation and user feedback.

4. The computer-readable medium of claim 1, wherein the operations further comprise one or more of splitting or merging of the sections, rolling back of one or more of the sections to one or more previous versions, modifying of the complete content, or editing of the TOC.

5. The computer-readable medium of claim 1, wherein the computing device comprises processing circuitry coupled to a memory, the processing circuitry comprising one or more of application processing circuitry or graphics processing circuitry.

6. A computing device comprising:
processing circuitry to:
generate a hierarchical table of contents (TOC) having section headings relating to a document to be assembled;
construct a graph having nodes corresponding to one or more of section headings associated with sections and graph edges corresponding to section dependencies associated with the section headings; and
assemble the document by concatenating section contents corresponding to the section headings based on a user-defined formatting template.

7. The computing device of claim 6, wherein the processing circuitry is further to:
retrieve references for the document based on a retrieval-augmented generation (RAG), wherein the references are retrieved from one or more databases coupled to the computing device; and
assign one or more of the nodes to a specialized section-level large language model (LLM) to facilitate generating complete content for the document based on one or more of the retrieved references, the section contents, or context from the nodes.

8. The computing device of claim 6, wherein the processing circuitry is further to:
summarize the sections and propagating the summarized sections along the graph edges to prepare information to be used for generating subsequent documents; and
interactively refine the section contents based on summary propagation and user feedback.

9. The computing device of claim 6, wherein the processing circuitry is further to one or more of split or merge the sections, roll back one or more of the sections to one or more previous versions, modify the complete content, or edit the TOC.

10. The computing device of claim 6, wherein the processing circuitry is coupled to a memory, the processing circuitry comprising one or more of application processing circuitry or graphics processing circuitry.

11. A method comprising:
generating, by a computing device, a hierarchical table of contents (TOC) having section headings relating to a document to be assembled;
constructing a graph having nodes corresponding to one or more of section headings associated with sections and graph edges corresponding to section dependencies associated with the section headings; and
assembling the document by concatenating section contents corresponding to the section headings based on a user-defined formatting template.

12. The method of claim 11, further comprising:
retrieving references for the document based on a retrieval-augmented generation (RAG), wherein the references are retrieved from one or more databases coupled to the computing device; and
assigning one or more of the nodes to a specialized section-level large language model (LLM) to facilitate generating complete content for the document based on one or more of the retrieved references, the section contents, or context from the nodes.

13. The method of claim 11, further comprising:
summarizing the sections and propagating the summarized sections along the graph edges to prepare information to be used for generating subsequent documents; and
interactively refining the section contents based on summary propagation and user feedback.

14. The method of claim 11, further comprising one or more of splitting or merging of the sections, rolling back of one or more of the sections to one or more previous versions, modifying of the complete content, or editing of the TOC.

15. The method of claim 11, wherein the computing device comprises processing circuitry coupled to a memory, the processing circuitry comprising one or more of application processing circuitry or graphics processing circuitry.
